(19) United States
(12) Patent Application Publication
(10) Pub. No.: US 2011/0078282 A1
(43) Pub. Date: Mar. 31, 2011

(54) Network device that downloads files using its ID code and method thereof

(75) Inventors: Bo Er Wei, Taipei (TW); Wei Shiau Suen, Taipei (TW)

(73) Assignee: Moxa Inc., Taipei (TW)

(21) Appl. No.: 12/585,813

(22) Filed: Sep. 25, 2009

(51) Int. Cl. G06F 15/16; G06F 17/30

(52) U.S. Cl. 709/219; 707/E17.01

(57) ABSTRACT

A network device that downloads files using its ID code and the corresponding method are disclosed. After the network device obtains its IP address, it generates a download command for downloading a target file corresponding to the device ID code. After transmitting the download command to a server, the network device receives the target file returned from the server. Therefore, the invention achieves the goal of automatically downloading a target file for the network device without manual operations.

### BACKGROUND OF THE INVENTION

1. Field of Invention

The invention relates to a network device that automatically downloads files and the method thereof. In particular, the invention relates to a network device that automatically downloads files using its ID code and the method thereof.

2. Related Art

Before a user uses an existing network device with the Internet protocol (IP), he/she has to make initial settings so that the network device can operate normally on the Internet.

The settings of usual network devices include IP address, subnet mask (netmask), gateway, etc. Besides, depending on the services provided by the network device, there are also other specific settings. For example, a wireless Access Point (AP) needs the settings of the service set identifier (SSID) and security setting. A device server needs the setting of operating mode. Thus, different network devices have different setting items.

Suppose there are many network devices to perform settings for. For example, a device manufacturer that uses embedded network module in the network device needs to set the embedded network module in each network device so that the embedded network module and the network device can function correctly and can connect to the Internet afterwards. In this case, the device manufacturer has to hire people to manually set the network devices. This increases manpower, working time and cost.

To reduce the manpower, time, and cost for setting the network devices, a solution of using a configuration file to perform environment settings is proposed. Same network device can thus download a universal configuration file from a server for environment settings. This method is largely used by manufacturers. However, in fact, various network devices have different environments and uses. Therefore, even the same network devices may not use the same configuration file. If one wants to use the above-mentioned solution for the network devices to download different configuration files, manufacturers have to provide such files. This still increases the manpower, time, and cost.

In summary, the prior art always has the problem of requiring more manpower, time, and cost for preparing files for network device settings. It is therefore necessary to provide a better solution.

### SUMMARY OF THE INVENTION

In view of the foregoing, the invention discloses a network device that downloads files according to its ID code and the method thereof.

The disclosed network device includes: a storage module for storing the device ID code thereof, an IP address extracting module for obtaining a device IP address, a command generating module for generating a download command for a target file corresponding to the device ID code, and a transmission module for transmitting the download command to a server and receiving the target file returned from the server.

The disclosed method includes the steps of: obtaining a device IP address; setting the network device to use the device IP address; generating a download command for the target file corresponding to the device ID code; transmitting the download command to a server; and receiving the target file returned from the server.

The invention as described above differs from the prior art in the following. After the invention obtains the device IP address, it downloads the target file corresponding to the device ID code, thereby solving the problem in the prior art. In addition to achieving the objective of letting the network device automatically download files without manual settings, it is also possible for one network device to have different settings for different operating environments.

### BRIEF DESCRIPTION OF THE DRAWINGS

The invention will become more fully understood from the detailed description given herein below illustration only, and thus is not limitative of the present invention, and wherein:

FIG. 1 shows the system structure of downloading files using the device ID code according to the invention.

FIG. 2 shows the elements inside the disclosed network device that downloads files using the device ID code.

FIG. 3A is a flowchart of the disclosed method of downloading files using the device ID code.

FIG. 3B is another flowchart of the disclosed method of downloading files using the device ID code.

FIG. 4 is a schematic view of the operating environment configuration file according to the invention.

FIG. 5A is yet another flowchart of the disclosed method of downloading files using the device ID code.

FIG. 5B is yet another flowchart of the disclosed method of downloading files using the device ID code.

### DETAILED DESCRIPTION OF THE INVENTION

The present invention will be apparent from the following detailed description, which proceeds with reference to the accompanying drawings, wherein the same references relate to the same elements.

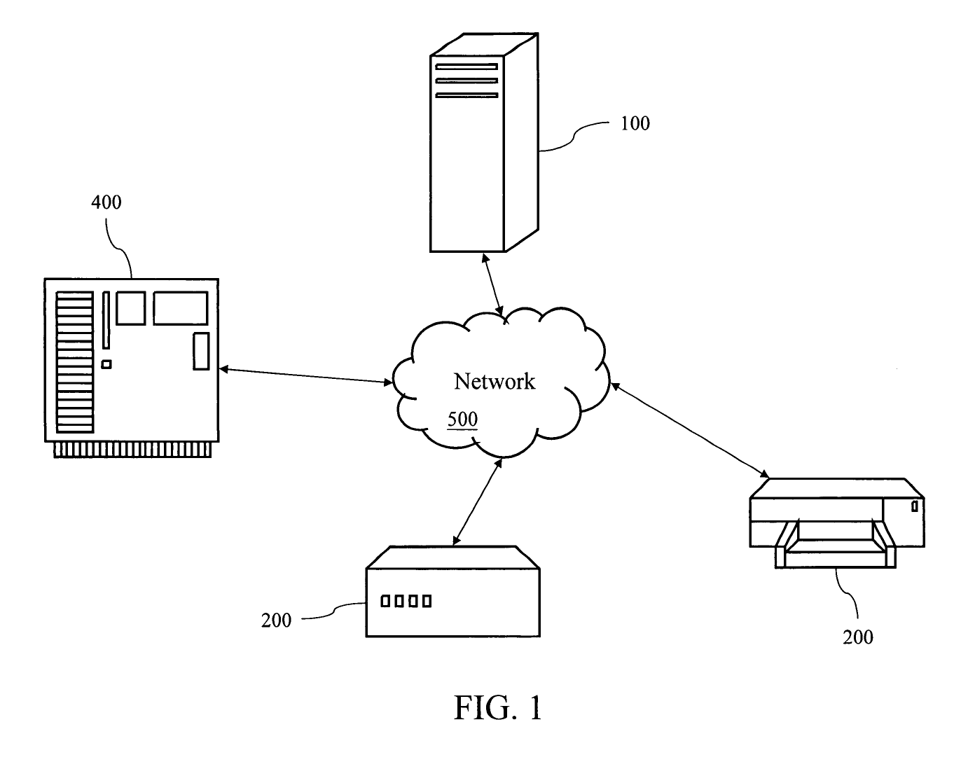

In order not to manually set the network device, the invention proposes the concept of letting the network device automatically download files. It is based on the network 500 in FIG. 1. In addition to a network device 200, the network 500 also includes a server 100.

Since the server 100 operates on the network 500, it has a fixed IP address. In this specification, the IP address used by the server 100 is called a target IP address.

The server 100 stores target files for network devices 200 to download. In particular, the target files stored in the server 100 include the configuration files, firmware, manuals, or secure socket layer (SSL) certificates of network devices 200.

If the target file is a configuration file of the network device 200, then it includes the device IP address, subnet mask, and gateway. Besides, for different services provided by the network device, the target file further records such information as wireless service set identifier (SSID), security setting (when the network device 200 is a wireless AP), or operating mode (when the network device 200 is a server). In general, items in the target file of the invention are not limited to these examples. Any settings that need to be set manually for the network device can be included in the target file. Besides, the target file can use commands to record various items or use a predetermined format to do so.

Once the download command sent out from the network device 200 for the target file is received, the server 100 reads the corresponding target file and transmits it to the network device 200 that sends out the download command. The download commands have different data formats according to different file downloading services provided by the server 100. However, the data contained in the download command are sufficient for the server 100 to read the target file. For example, if the download command contains the filename of the target file, then the server 100 can readily read the target file according to the filename. If the download command does not contain the filename of the target file, then the server 100 use other data in the download command to determine the correct filename. In general, there may be one or more files to download.

Under the premise of providing the above-mentioned files for network devices 200 to download, the server 100 allows the network devices 200 to use the File Transfer Protocol (FTP), Trivial File Transfer Protocol (TFTP) or HyperText Transfer Protocol (HTTP) to connect to the server 100 for target file downloads. However, the invention is not limited by these examples. Generally speaking, since the TFTP is a protocol for remote computers to read or write files and it uses the User Datagram Protocol (UDP) for the data transmissions without verification or security mechanism, the server 100 is often of this type in a private network.

The network device 200 can obtain a target file of specific purpose from the server 100 according to the invention. Possible network devices 200 include printers, routers, wireless AP's, and device servers. The invention is not limited to these examples.

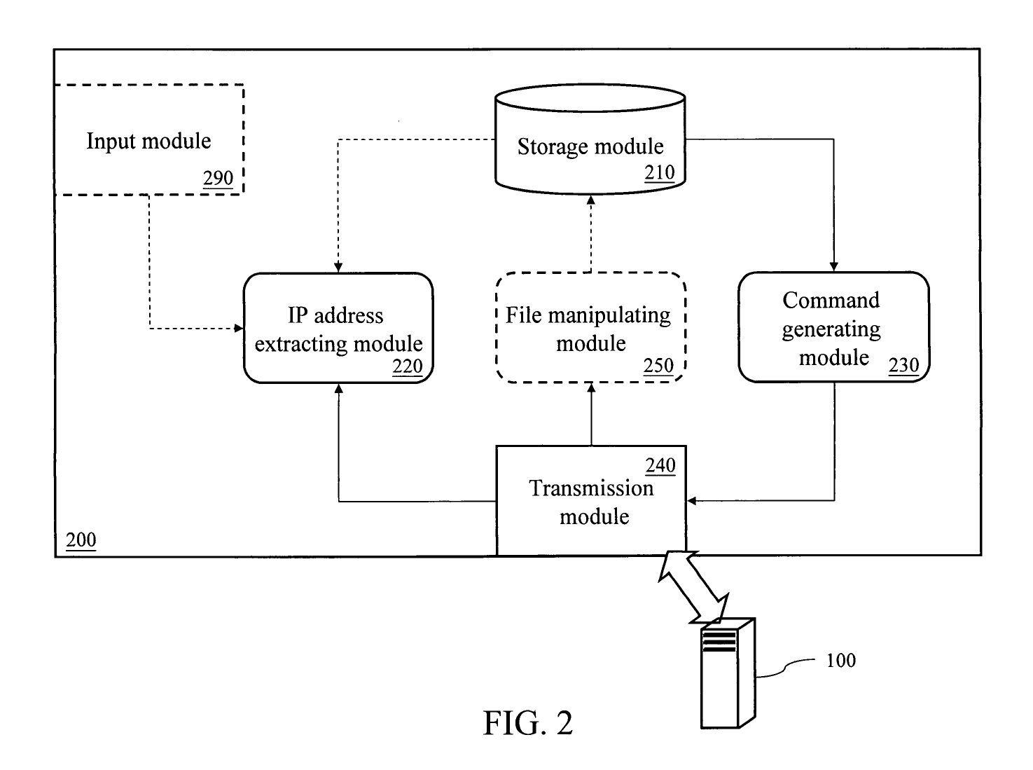

The following description uses FIG. 2 to explain the internal elements of the network device 200 referred herein. As shown in the drawing, the disclosed network device 200 includes a storage module 210, an IP address extracting module 220, a command generating module 230, and a transmission module 240.

The storage module 210 stores the device ID code of the network device 200. The device ID code according to the invention includes, but not limited to, model and MAC number of the network device 200. It can also represent the predetermined data string of the network device. In most cases, the storage module 210 stored the model or MAC number.

The storage module 210 may be accessible to network devices 200. The device ID code may also be burned into the storage module 210, so that the network device 200 can only read the device ID code from but not write data into the storage module 210.

The IP address extracting module 220 obtains the device IP address. The device IP address is the IP address about to be used by the network device 200.

The IP address extracting module 220 can use the automatic IP address configuration technique to obtain the device IP address. For example, it can use the Automatic Private IP Addressing (APIPA) or Dynamic Host Configuration Protocol (DHCP)/Bootstrap Protocol (BOOTP) technique. But the invention is not limited to these implementations.

APIPA is a technique of obtaining a set of local IP address. The IP address extracting module 220 first selects an IP address from the 169.254.0.0/16 range. It then uses a packet of the Address Resolution Protocol (ARP) to inquire whether any other network device on the network 500 of the network device 200 is using the same IP address. If not, then the network device 200 can use this IP address. If another network device has occupied the IP address, then the IP address extracting module 220 finds another IP address and repeats the above steps, until an unused IP address is found.

The IP address extracting module 220 further uses the DHCP/BOOTP technique to obtain the device IP address via the transmission module 240. In this case, the IP address extracting module 220 first sends out a DHCP discovery packet to detect whether there is a DHCP server 400 on the network 500 of the network device 200. If there is then the DHCP server 400 returns a DHCP offer packet to the network device 200. Thus, the IP address extracting module can receive the DHCP offer packet via the transmission module 240, and extract the device IP address from it. It then transmits a DHCP request packet via the transmission module 240. This completes the DHCP request procedure.

Besides, the IP address extracting module 220 can obtain different device IP addresses from hardware or software parameters on the network device 200. For example, after reading out the data pre-stored in the storage module 210, it converts the readout data into a device IP address. It then reads the device ID code of the network device 200 from the storage module 210. The system then searches a pre-established correspondence table according to the device ID code, finding a corresponding device IP address. Alternatively, after detecting such input parameters as the dip switch or I/O signal of the network device 200, a binary value obtained out of a combination of the dip switch or I/O signal (e.g., ‘1010’) is used to define the device IP address ‘192.168.0.10’, for example. Yet another possibility is that the user uses a specific command for setting IP addresses, entered via the input module 290, to define the device IP address (e.g., ‘set devip 192.168.0.10’). However, the method for the IP address extracting module 220 to obtain the device IP address is not limited to these particular examples.

Moreover, the IP address extracting module 220 further obtains a target IP address (the one used by the server 100). Aside from being unable to use the APIPA technique to obtain the target IP address, the rest is similar to obtaining the device IP address. After reading a predetermined target IP address from the storage module 210, using DHCP/BOOTP to obtain the target IP address, and reading the device ID code of the network device 200 from the storage module 210, the IP address extracting module 220 finds a corresponding target IP address from the pre-established correspondence table according to the device ID code. Alternatively, the binary number out of a combination of the input parameters such as the dip switch or I/O signal of the network device 200 can be used to define the target IP address. Or the user can use a specific command for setting IP addresses, entered via the input module 290, to define the device IP address.

In fact, the IP address extracting module 220 can have more than one method to obtain the IP addresses. It can follow a predetermined order to obtain the IP address until one IP address is successfully found. For example, the IP address extracting module 220 can first try the DHCP technique. If unsuccessful, then it can try the APIPA technique. Likewise, the IP address extracting module 220 can first try the DHCP technique and, if failed, read a predetermined target IP address from the storage module 210. If the storage module 210 does not store any target IP address, then the device ID code is used to generate the target IP address.

The command generating module 230 reads from the storage module 210 the device ID code of the network device 200, and generates according to the device ID code a download command to be sent to the server 100. The command generating module 230 generates a corresponding download command according to the communication protocol used by the server 100. For example, the server 100 is a TFTP server, and the command generating module 230 generates the TFTP download command. If the server 100 is an HTTP server, then the command generating module 230 generates the HTTP download command.

In addition to generating download commands to be sent to the server 100, the command generating module 230 can also generate download commands that are broadcast to all network devices on the network 500. In general, the transmission protocol that supports broadcasting is based on UDP, such as TFTP. However, the invention is not limited to this particular example.

Since the server 100 may only provide the function of letting the network device 200 access a target file without other functions such as judging data (such as a TFTP server), the download command generated by the command generating module 230 needs to include the filename of the target file. This enables the server 100 to directly read out the target file accordingly after receiving the download command, and to return it to the network device 200. The command generating module 230 generates the filename according to the device ID code. For example, when the device model of the network device 200 is ‘NE-7100’ and its MAC number is ‘00:90:E8:12:34:56’, the filename generated by the command generating module 230 can be ‘ne7100.cfg’, ‘0090e8123456.frm’, or a combination of them ‘ ne7100-0090e8123456.doc’.

In fact, the command generating module 230 can read out a predetermined filename from the storage module 210, or generate a filename by the user via the input module 290 by entering the command ‘set filename file.ca’. The command generating module 230 can also use the binary value combined out of the device ID code and the dip switch or I/O signal to generate the filename after detecting the dip switch or I/O input parameter state of the network device 200. For example, suppose the four dip switches or I/O signals are ‘1001’. Then it generates the filename ‘ne7100-p9.cfg’. Of course, the invention is not limited to the above-mentioned examples.

Suppose the network 500 of the network device 200 includes a DHCP server 400. When the IP address extracting module 220 asks for the device IP address and/or target IP address from the DHCP server 400 using the DHCP, the DHCP server 400 returns the device IP address and/or target IP address. In addition, when returning the target filename, the command generating module 230 can use the DHCP server 400 to return the target filename and use the device ID code to generate the filename of the target file to be downloaded.

The transmission module 240 transmits the download command generated by the command generating module 230 for the server 100 to the server 100 that uses the target IP address. It further receives the target file returned by the server 100 according to the download command. If the server 100 does not return the target file for some time, or the server returns a message meaning that there is no corresponding target file, then the transmission module 240 cannot receive the target file using the server with the target IP address.

The transmission module 240 also broadcasts the download command generated by the command generating module 230 to the network 500. Thus, all servers that connect to the network device 200 via the network 500 can receive the download command broadcast by the transmission module 240. If some server can provide the target file requested by the download command, then the transmission module 240 receives the target file returned from the server.

Generally speaking, if the IP address extracting module 220 cannot obtain the target IP address or the transmission module 240 cannot receive the target file from the server 100 using the target IP address, then the command generating module 230 generates a broadcasting download command when the server 100 can provide file download service using the broadcasting transmission protocol. The download command is then sent to the network 500 of the network device 200 via the transmission module 240 by broadcasting. However, the invention is not limited to this example. After the IP address extracting module 220 obtains the device IP address, the command generating module 230 can directly generates a broadcasting download command and broadcast it to the network 500 via the transmission module 240.

Besides, the network device 200 further includes a file manipulating module 250 for manipulating the target file received by the transmission module 240. For example, when the target file is a configuration file of the network device 200, the file manipulating module 250 sets the operating environment of the network device 200 according to the configuration file. The network device 200 can operate according to various setting values in the configuration file. When the target file is firmware of the network device 200, the file manipulating module 250 updates the firmware thereof. When the target file is a manual or SSL certificate of the network device 200, the file manipulating module 250 stores the target file to the storage module 210 for subsequent uses.

If the target file is an operating environment configuration file of the network device 200 and the configuration file contains commands, then the file manipulating module 250 can directly executes the commands therein to set the operating environment of the network device 200. If the configuration file records various items in a predetermined format, the network device 200 saves the settings to the corresponding environment variables after reading them out. In most cases, the environment variables set by the file manipulating module 250 exist in the memory of the network device 200.

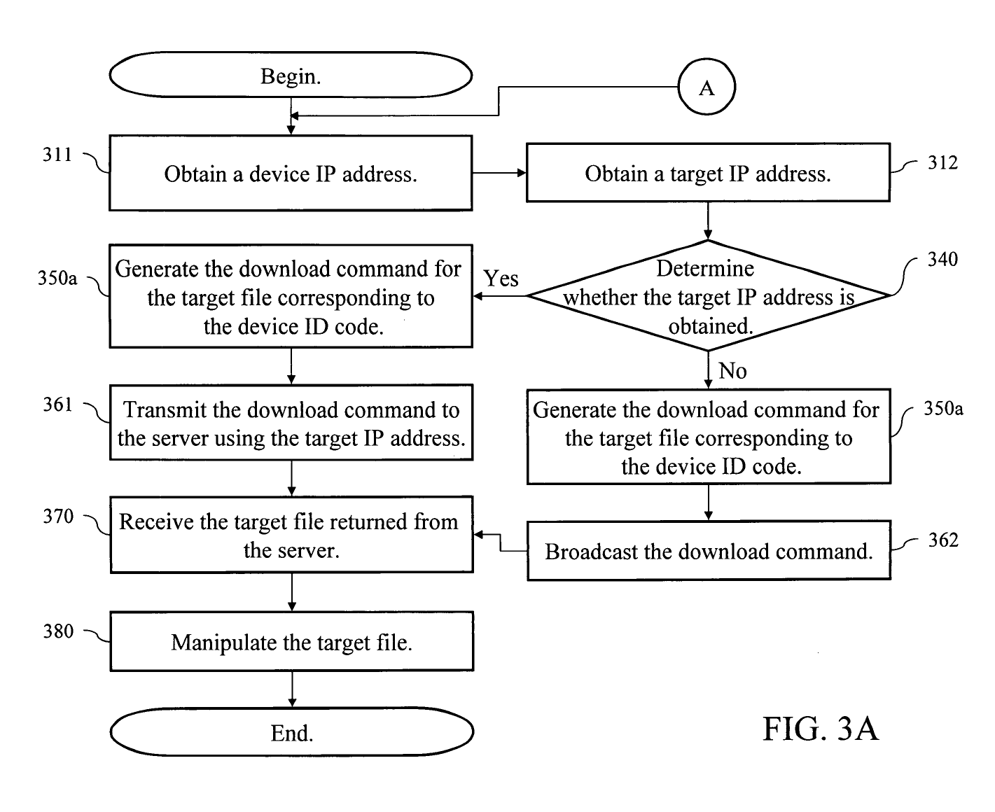

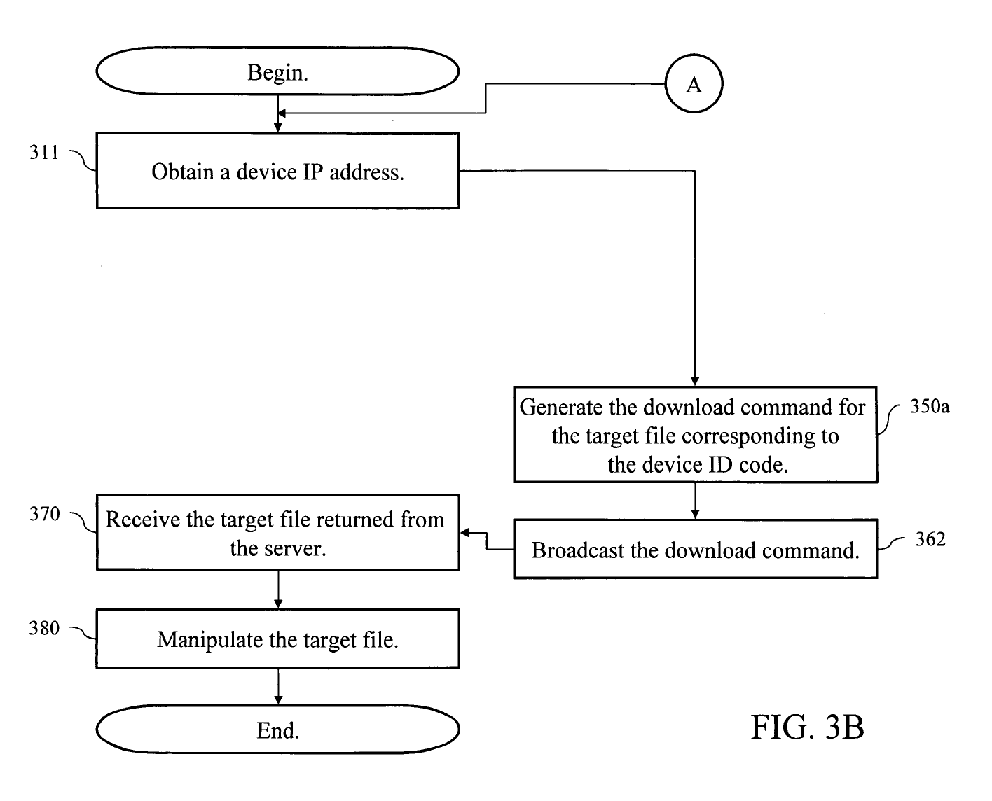

In the following, a first embodiment is used to explain the operating method of the invention. Please refer to FIG. 3A for the flowchart of the disclosed method. In this embodiment, the server 100 is assumed to be a TFTP server. However, the invention is not limited to this example. Besides, we suppose the target file is an operating environment configuration file of the network device 200. The invention is also not limited to this case.

First, after the user connects the transmission module in the network device 200 with the network 500 containing the TFTP server 100, the IP address extracting module 220 in the network device 200 tries to obtain the device IP address (step 311). Suppose in this embodiment the IP address extracting module 220 uses the APIPA technique to obtain the device IP address ‘169.254.4.13’. In this case, the transmission module 240 in the network device 200 uses the device IP address ‘169.254.4.13’ and other network device 200 on the network 500 to transmit data.

After the IP address extracting module 220 obtains the device IP address (step 311), it further tries to obtain the target IP address (step 312). Here we assume that the IP address extracting module 220 reads out the target IP address ‘169.254.2.8’ from the storage module 110. However, the invention is not limited to this possibility.

After the IP address extracting module 220 obtains the device IP address (step 311), the command generating module 230 in the network device 200 generates a download command according to the device ID code for the TFTP server to download the target file corresponding to the device ID code (step 350a). The target file in this embodiment is the operating environment configuration file. In this embodiment, the server 100 is a TFTP server. According to the definitions in the TFTP, the command for a client to download a file from the TFTP server only needs to contain the filename of the file to download. Therefore, the command generated by the command generating module 230 is simply the filename of the operating environment configuration file of the network device 200. Suppose the files stored in the TFTP server are named after the MAC number of the network device 200, then the command generating module 230 uses the MAC number ‘00:90:E8:80:04:13’ of the network card of the network device 200 that is connected to the TFTP server via the network 500 to generate the filename ‘0090e8800413.cfg’ of the operating environment configuration file. It sets the filename ‘0090e8800413.cfg’ in the download command. But the method of generating the download command by the command generating module 230 is not limited to this particular example.

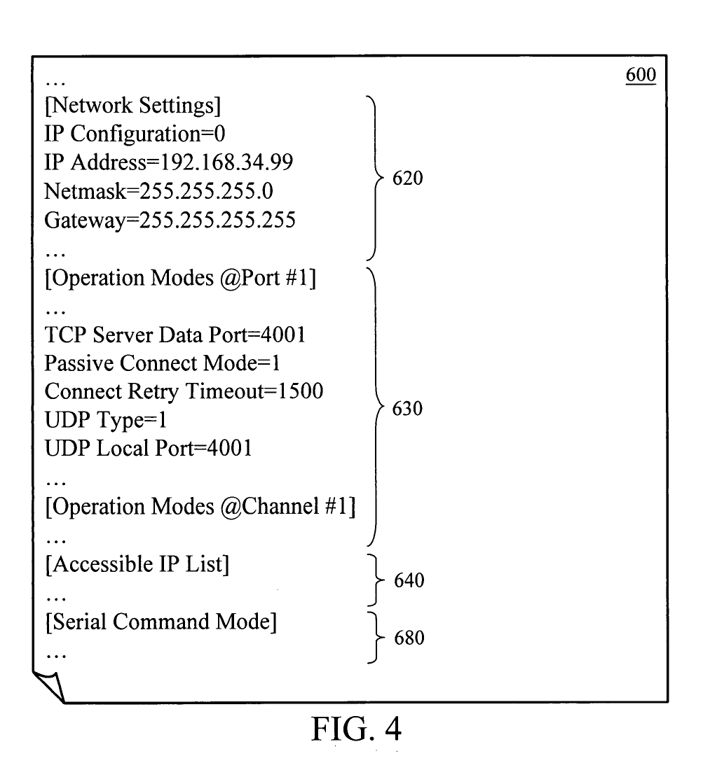

After the command generating module 230 generates the download command (step 350a), the transmission module 240 in the network device 200 transmits the download command that contains the filename of the target file to the TFTP server using the target IP address ‘169.254.2.8’ (step 361). After the TFTP server receives the download command transmitted from the transmission module 240, it reads the operating environment configuration file 600 in FIG. 4 from the directory storing the operating environment configuration files according to the filename ‘0090e8800413.cfg’ in the download command. It further transmits the operating environment configuration file 600 back to the network device 200. Afterwards, the transmission module 240 in the network device 200 receives the operating environment configuration file 600 returned by the TFTP server in response to the download command (step 370). Consequently, the network device 200 can download its operating environment configuration file 600 without any settings by the user.

After the transmission module 240 in the network device 200 receives the target file returned by the TFTP server in response to the download command (step 370), the file manipulating module 250 in the network device 200 operates the target file using a predetermined method (step 380). Since the target file is an operating environment configuration file of the network device 200, the file manipulating module 250 follows the network configuration 620, operating configuration 630, accessible IP list 640, and serial command configuration 680 in the operating environment configuration file 600 to set the operating environment of the network device 200. However, the invention is not limited to this. Using the uniqueness of the MAC number, each network device can use the corresponding target file to set its operating environment. Consequently, the network device 200 does not require manual settings. Moreover, even the same network device can have different operating environments, such as different network configurations or accessible IP lists.

In fact, during the above-mentioned procedure after the command generating module 230 tries to obtain the target IP address using the IP address extracting module 220 (step 312), the invention determines whether the target IP address is successfully obtained (step 340). If so, then the command generating module 230 generates a download command to be transmitted to the TFTP server (step 350a), as described above. If not, then the command generating module 230 generates the download command for the transmission module 240 to broadcast (step 350a). Therefore, after the transmission module 240 broadcasts the download (step 362), other TFTP servers on the network 500 receive the broadcast from the transmission module 240. It determines whether the target file requested by the network device 200 exists according to the target file in the broadcasting download command. If so, then the target file is transmitted back to the network device 200. Thus, the transmission module 240 can receive the request target file (step 370).

After the transmission module 240 transmits the download command to the TFTP server, the command generating module 230 determines whether the transmission module 240 receives the target file returned from the TFTP server. If not, then the command generating module 230 executes a procedure similar to the above-mentioned steps and generates the broadcasting download command (step 350a) for the transmission module 240 to broadcast (step 362).

Even as shown in FIG. 3B, after the IP address extracting module 220 obtains the device IP address (step 311), the command generating module 230 generates the download command corresponding to the target file of the device ID code (step 350a). After the transmission module 240 broadcasts to other network devices on the network 500 (step 362), the invention waits for any server on the network 500 to return the target file corresponding to the device ID code. When some server on the network 500 stores the target file with the corresponding device ID code, the transmission module 240 receives the target file of the device ID code returned from the server (step 370). Therefore, the network device 200 can perform subsequent manipulations on the target file.

In the above embodiment, if the number of target files for the network device 200 to download from the TFTP server is more than one, then the command generating module 230 further generates a download command according to the device ID code after the transmission module 240 receives a target file returned from the TFTP server in response to the previous download command (step 370). Suppose the file being downloaded this time is firmware of the network device 200. The command generating module 230 also uses the MAC number ‘00:90:E8:80:04:13’ of the network card used by the network device 200 to connect with the TFTP server via the network 500 to generate the filename of the firmware ‘0090e8800413.frm’. The firmware filename ‘0090e8800413.frm’ is set into the new download command (step 350a). After the transmission module 240 sends the download command of downloading firmware to the TFTP server (step 361), it receives the firmware returned from the TFTP server (step 370).

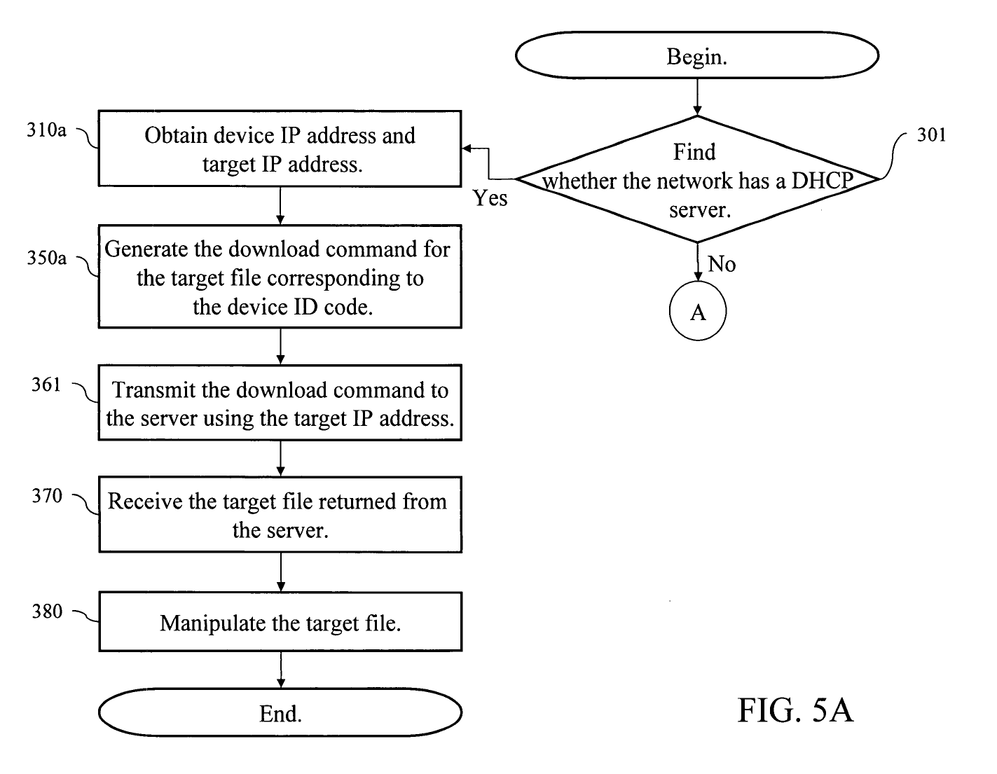

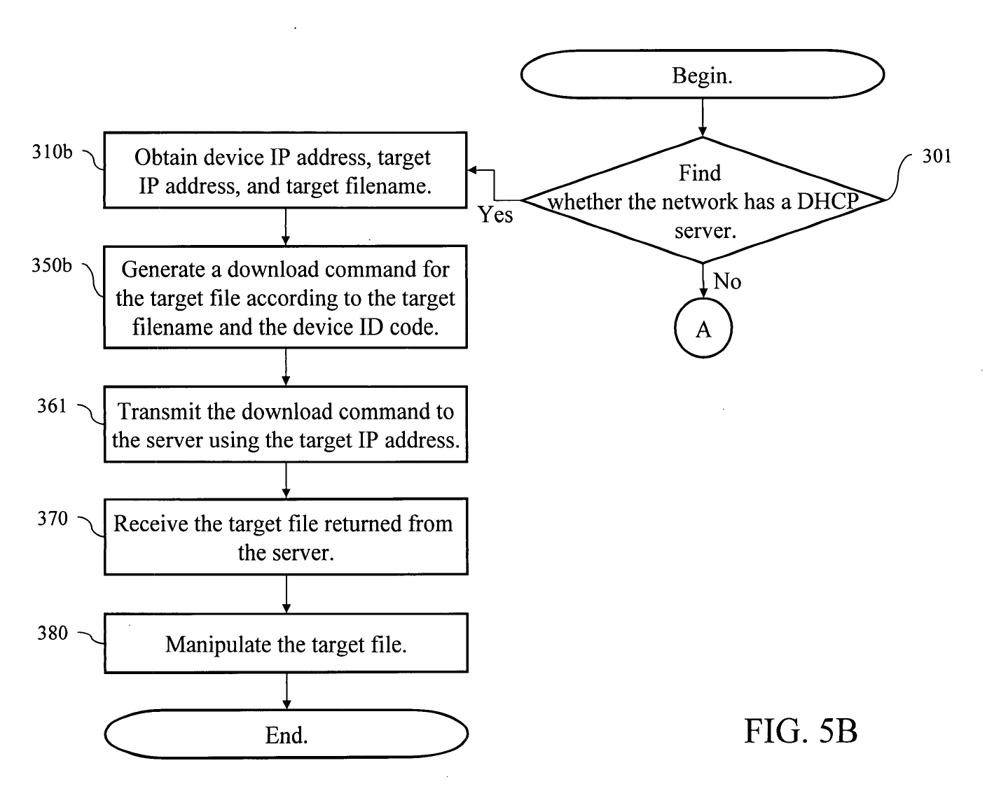

In fact, the invention is not limited to the embodiment of letting the network device 200 download the configuration file from the server 100 and setting its operating environment. It can also automatically connect and download firmware from the server 100, or even download a specific file for subsequent uses. The following paragraphs use a second embodiment to explain other uses of the invention. Please refer to FIG. 5A at the same time for the flowchart of the disclosed method of using the device ID code to download files. In this embodiment, the server 100 is an HTTP server as an example. The invention, however, is not limited to this.

After the user connects the transmission module 240 in the network device 200 with the network 500 contain the HTTP server (server 100), the IP address extracting module 220 in the network device 200 tries to obtain the device IP address. The IP address extracting module 220 first uses the DHCP technique to search whether there is a DHCP server 400 in the network 500 via the transmission module 240 (step 301). When no DHCP server 400 exists in the network 500, the IP address extracting module 220 continues to use the method mentioned in the first embodiment (see FIG. 3A) to obtain the device IP address and the target IP address. This part is not repeated here. If there is a DHCP server 400 in the network 500, the DHCP server 400 returns the device IP address to the network device 200 via DHCP packet. Suppose in this embodiment the device IP address received by the transmission module 240 of the network device 200 from the DHCP server 400 is ‘172.16.4.13’.

In fact, the DHCP packet which is replied to the network device 200 from the DHCP server 400 can further include the target IP address ‘172.16.2.8’. Thus, the network device 200 obtains the device IP address and the target IP address (step 310a). However, the DHCP server 400 referred herein is not limited to returning the target IP address to the network device 200. It can also return a predetermined target filename to the network device 200 (FIG. 5B, step 310b).

Suppose in this embodiment the IP address extracting module 220 can obtain the device IP address and the target IP address via the DHCP server 400 (step 310a). Afterwards, the transmission module 240 of the network device 200 uses the device IP address ‘172.16.4.13’ to transmit data with other network devices on the network 500.

Afterwards, the command generating module 230 of the network device 200 generates the download command for the target file corresponding to the device ID code according to the device ID code (step 350a). Suppose the target file is a firmware update file, network device manual, or SSL certificate (but the invention is not limited to these examples). Since in this embodiment the server 100 is an HTTP server, the download command generated by the command generating module 230 is an HTTP request. The requested target is the firmware update file, manual, or SSL certificate of the network device 200. Suppose the file stored in the HTTP server is named after the model of network device 200. For example, if the model of network device 200 is ‘NE-1700’, then the command generating module 230 generates the download command of ‘GET/ne1700.frm’, ‘GET/ne1700.doc’, or ‘GET/ne1700.ctf’, where ‘ne1700.frm’, ‘ne1700.doc’, and ‘ne1700.ctf’ are the filenames of the firmware file, manual, and SSL certificate of the network device, respectively.

Suppose in this embodiment the DHCP server 400 also returns the target filename such as ‘ne1700.frm’, ‘ne1700.doc’, or ‘ne1700.ctf’ to the network device 200 in addition to the device IP address and target IP address. The command generating module 230 of the network device 200 obtains the target filename (step 310b). Then the command generating module 230 generates the download command for the target file according to the target filename and the device ID code (step 350b), such as ‘0090e8800413_ne1700.frm’, ‘0090e8800413_ne1700.doc’, or ‘0090e8800413_ne1700.ctf’.

After the command generating module 230 generates the download command (steps 350a or 350b), the transmission module 240 of the network device 200 sends the download command containing the target file (HTTP request) to the HTTP server with the target IP address ‘172.16.2.8’ (step 361). After the HTTP server receives the download command transmitted from the transmission module 240, it reads the target file according to the filename therein (‘ne1700.frm’, ‘ne1700.doc’, or ‘ne1700.crt’), and sends it by HTTP reply to the network device 200.

After the transmission module 240 of the network device 200 receives the target file returned from the HTTP server (step 370), the file manipulating module 250 processes the target file in a predetermined method (step 380). For example, the firmware update file is used to update the firmware. Or the manual/SSL certificate of the network device is stored in the storage module 210 for the user to use.

In summary, the invention differs from the prior art in that after the network device 200 obtains the device IP address, it generates a download command for the target file corresponding to the device ID code. The download command is then transmitted to the server 100 for downloading the target file. This technique can solve problems existing in the prior art. This further achieves the goal of letting the network device automatically download target files. Moreover, the same network device can be set to have different operating environments. Besides, the disclosed method of downloading files using the device ID code can be implemented in hardware, software, or the combination of hardware and software.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of using a device identification (ID) code to download a file used in a network device with the device ID code, comprising the steps of:
obtaining a device IP address;
setting the network device to use the device IP address;
generating a download command for a target file corresponding to the device ID code;
transmitting the download command to a server; and
receiving the target file returned from the server.

2. The method of using a device ID code to download a file according to claim 1, wherein the step of obtaining a device IP address obtains the device IP address using the Automatic Private IP Addressing (APIPA) technique.

3. The method of using a device ID code to download a file according to claim 1, wherein the step of generating a download command for a target file corresponding to the device ID code generates the download command according to the device model, MAC number and/or input parameter contained in the device ID code.

4. The method of using a device ID code to download a file according to claim 1, wherein the step of transmitting the download command to the server further includes the step of first obtaining a target IP address used by the server and then transmitting the download command to the server using the target IP address.

5. The method of using a device ID code to download a file according to claim 4, wherein the step of obtaining a target IP address used by the server reads a predetermined target IP address, reads the target IP address corresponding to the device ID code, or defines the target IP address according to a specific command.

6. The method of using a device ID code to download a file according to claim 1, wherein the step of transmitting the download command to a server broadcasts the download command to the server.

7. The method of using a device ID code to download a file according to claim 1 further comprising the step of searching a Dynamic Host Configuration Protocol (DHCP) server on a network of the network device and obtaining the device IP address using the DHCP.

8. The method of using a device ID code to download a file according to claim 7, wherein the step of obtaining the device IP address using the DHCP further includes the step of obtaining a target IP address used by the server using the DHCP.

9. The method of using a device ID code to download a file according to claim 7, wherein the step of generating a download command for a target file corresponding to the device ID code is preceded by the step of obtaining a target filename returned according to the DHCP so that the download command is generated according to the target filename and the device ID code.

10. A network device using a device ID code to download a file, comprising:
a storage module, which stores a device ID code of the network device;
an IP address extracting module, which obtains a device IP address;
a command generating module, which generates a download command of at least a target file, wherein the target file corresponds to the device ID code; and
a transmission module, which uses the device IP address to transmit the download command to a server and receives the target file returned from the server.

11. The network device according to claim 10, wherein the IP address extracting module obtains the device IP address using the APIPA technique.

12. The network device according to claim 10, wherein the command generating module generates the download command according to the device model, MAC number and/or input parameter contained in the device ID code.

13. The network device according to claim 10, wherein the download command includes a filename of the target file.

14. The network device according to claim 10, wherein the IP address extracting module further reads a predetermined target IP address form the storage module, reads the target IP address corresponding to the device ID code, or defines the target IP address according to a specific command so that the transmission module transmits the download command to the server using the target IP address.

15. The network device according to claim 10, wherein the transmission module broadcasts the download command.

16. The network device according to claim 10, wherein the IP address extracting module further uses the transmission module to find out whether a network of the network device has a DHCP server and uses the transmission module to receive the device IP address returned from the DHCP server.

17. The network device according to claim 16, wherein the IP address extracting module further uses the transmission module to obtain a target IP address used by the DHCP server.

18. The network device according to claim 16, wherein the transmission module further receives a target filename transmitted from the DHCP server and the command generating module further generates the download command of the target file according to the target filename and the device ID code.

19. The network device according to claim 10 further including a file manipulating module for setting the operating environment of the network device according to the target file, updating the firmware of the network device according to the target file, or storing the target file to the storage module.
